(19) United States
(12) Patent Application Publication
(10) Pub. No.: US 2025/0103765 A1
(43) Pub. Date: Mar. 27, 2025

(54) METHOD FOR PREDICTING THREE-DIMENSIONAL FROST HEAVING DEFORMATION OF FORMATION DURING FREEZING CONSTRUCTION OF METRO TUNNEL

(71) Applicant: Anhui University of Science and Technology, Huainan, Anhui (CN)

(72) Inventors: Haibing CAI, Huainan (CN); Mengkai LI, Huainan (CN); Rongbao HONG, Huainan (CN); Fangxing YAO, Huainan (CN); Shi HU, Huainan (CN); Zhe YANG, Huainan (CN); Changqiang PANG, Huainan (CN); Xianwen HUANG, Huainan (CN)

(21) Appl. No.: 18/282,967

(22) PCT Filed: May 31, 2023
(86) PCT No.: PCT/CN2023/097355

§ 371 Date: Sep. 19, 2023

(30) Foreign Application Priority Data
Jun. 13, 2022 (CN) 202210660022.5

(51) Int. Cl. G06F 30/20; G06F 113/14; G06F 119/08

(52) U.S. Cl. CPC G06F 30/20; G06F 2113/14; G06F 2119/08

(57) ABSTRACT

The present disclosure provides a method for predicting a three-dimensional frost heaving deformation of a formation during freezing construction of a metro tunnel and relates to the field of metro tunnel construction. The method includes: firstly determining a freezing construction position, obtaining soil horizon parameters of undisturbed soil within a range of a freezing wall, determining thermophysical and mechanical parameters of soil, layering a soil horizon above the freezing wall according to soil horizon properties thereof and existing buildings (structures), and determining a horizon where a frost heaving influence range exists; subsequently calculating an unsteady temperature field of a single freezing pipe and a radius of a freezing front; then calculating an inner radius and an outer radius of the freezing front after closure of the freezing wall according to a tunnel excavation type, and calculating a frost heaving region; and finally calculating a frost heaving displacement.

### CROSS REFERENCE TO RELATED APPLICATION

This patent application is a national stage application of International Patent Application No. PCT/CN2023/097355, filed on May 31, 2023, which claims the benefit and priority of Chinese Patent Application No. 202210660022.5 filed with the China National Intellectual Property Administration on Jun. 13, 2022, and entitled “METHOD FOR PREDICTING THREE-DIMENSIONAL FROST HEAVING DEFORMATION OF FORMATION DURING FREEZING CONSTRUCTION OF METRO TUNNEL”, the disclosure of which is incorporated by reference herein in its entirety as part of the present application.

### TECHNICAL FIELD

The present disclosure relates to the technical field of metro tunnel construction, and in particular, to a method for predicting a three-dimensional frost heaving deformation of a formation during freezing construction of a metro tunnel.

### BACKGROUND

With the rapid development of the society, urban underground rail transit has developed rapidly. Freezing, as an important means for formation consolidation, has been extensively used in urban rail transit projects, and can achieve significant consolidation effect especially under complicated geological conditions such as a rich water content, a mucky formation, and a sandy formation. However, artificial freezing causes a formation temperature to reduce sharply. A formation deformation induced by freezing construction of a metro tunnel mainly manifests as bad deformations of a surrounding building foundation, a tunnel lining, a base station bottom slab, and the like caused by frost heaving of the formation. Therefore, accurately and reliably predicting three-dimensional frost heaving of a formation caused by freezing construction is crucial for freezing wall design and existing building protection. Generally, there are several methods for studying a formation deformation: an empirical method, a numerical simulation method, and an analytical method, where the analytical method is commonly used. The analytical method based on strict mathematical derivation may take into account influences of geological parameters and freezer parameters and is a practical method for predicting a formation deformation caused by freezing construction of a tunnel. However, a formation uplift obtained from a current study on a formation deformation caused by frost heaving is a final formation uplift value, and actual conditions such as a time effect and a soil horizon temperature are not taken into account. Thus, a formation freezing speed and a frost heaving displacement cannot be predicted accurately.

### SUMMARY

An embodiment of the present disclosure provides a method for predicting a three-dimensional frost heaving deformation of a formation during freezing construction of a metro tunnel that can effectively solve the problem of uneven frost heaving of a formation caused by freezing construction of a metro tunnel and avoid causing bad deformations of existing surrounding building foundations and tunnel linings.

To achieve the above objective, the embodiment of the present disclosure provides the following technical solutions.

A method for predicting a three-dimensional frost heaving deformation of a formation during freezing construction of a metro tunnel includes the following steps:
(1) determining a freezing construction position, obtaining soil horizon parameters of undisturbed soil within a range of a freezing wall, determining thermophysical and mechanical parameters of soil, layering a soil horizon above the freezing wall, and determining a horizon where a frost heaving influence range exists;
(2) calculating an unsteady temperature field of a single freezing pipe and a radius r(t) of a freezing front;
(3) calculating an inner radius R₁(t) and an outer radius R₂(t) of the freezing front after closure of the freezing wall according to a tunnel excavation type, and calculating a frost heaving region Δ(t) by the following formulas:

$$Δ ( t ) = {\int }_{{R}_{1} ( t )}^{{R}_{2} ( t )} ( 1 + {ε}_{f} ) dr = 2 B \sqrt{t} ( 1 + {ε}_{f} ) ; and$$

$${ε}_{f} = {ε}_{f 0} exp ( - bP ) ;$$

where t represents a freezing time; ε_{f} represents a frost heaving ratio of soil under a load; ε_{f0} represents a frost heaving ratio of soil with no load; P represents a load of the horizon where the frost heaving influence range exists, kPa; b represents a constant of 0.001; B represents a coefficient; and r represents a freezing radius; and
(4) calculating a frost heaving displacement Wᵢ(t).

According to specific embodiments provided in the present disclosure, the present disclosure has the following technical effects:

The prediction method provided in the present disclosure takes into overall consideration thermophysical and mechanical parameters of soil, and factors such as freezing time effect, soil horizon freezing temperature, and soil horizon load, and can determine a frost heaving influence range and calculate a frost heaving displacement of a horizon where the frost heaving influence range exists by calculating an unsteady temperature field of a single freezing pipe and a radius r(t) of a freezing front and then calculating an inner radius R₁(t) and an outer radius R₂(t) of the freezing front after the closure of a freezing wall, and a frost heaving region Δ(t) based on a shape of a frozen region, in order to determine evolution laws of a freezing curtain and a frost heaving deformation at different stages. The reliability and accuracy of three-dimensional frost heaving prediction of a formation caused by freezing construction of a metro tunnel are improved. It is guaranteed that a prediction result is more conducive to providing reliable data reference and theoretical basis for actual construction.

### BRIEF DESCRIPTION OF THE DRAWINGS

To describe the technical solutions in the embodiments of the present disclosure or in the prior art more clearly, the accompanying drawings required in the embodiments will be briefly described below. Apparently, the accompanying drawings in the following description show merely some embodiments of the present disclosure, and other drawings can be derived from these accompanying drawings by those of ordinary skill in the art without creative efforts.

FIG. 1 is a schematic diagram of frost heaving layering according to the present disclosure;

FIG. 2 is a diagram illustrating a law of an unsteady freezing front of a single freezing pipe according to the present disclosure;

FIG. 3 is a diagram illustrating a law of an unsteady freezing front after closure of a freezing wall according to the present disclosure;

FIG. 4 is a schematic diagram of a formation uplift caused by unit frost heaving according to the present disclosure;

FIG. 5 is a schematic diagram of frost heaving of a formation with freezing construction t=60 days according to the present disclosure; and

FIG. 6 is a schematic diagram of frost heaving of a formation with freezing construction t=90 days according to the present disclosure.

### DETAILED DESCRIPTION OF THE EMBODIMENTS

The technical solutions in the embodiments of the present disclosure will be clearly and completely described below with reference to the accompanying drawings in the embodiments of the present disclosure. Apparently, the described embodiments are merely a part rather than all the embodiments of the present disclosure. All other embodiments derived from the embodiments in the present disclosure by a person of ordinary skill in the art without creative efforts shall fall within the protection scope of the present disclosure.

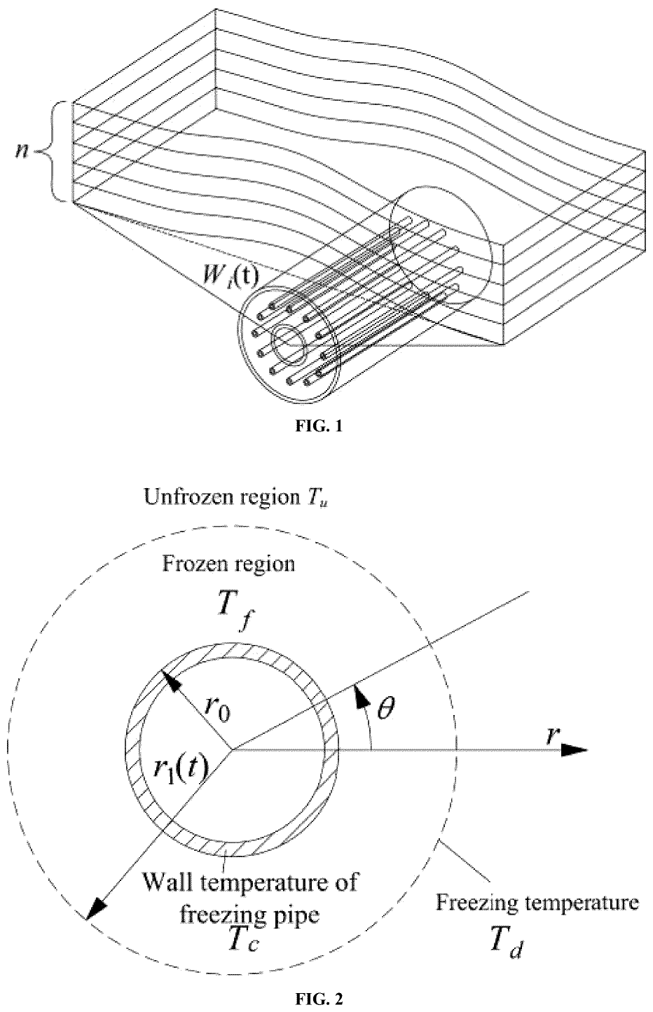

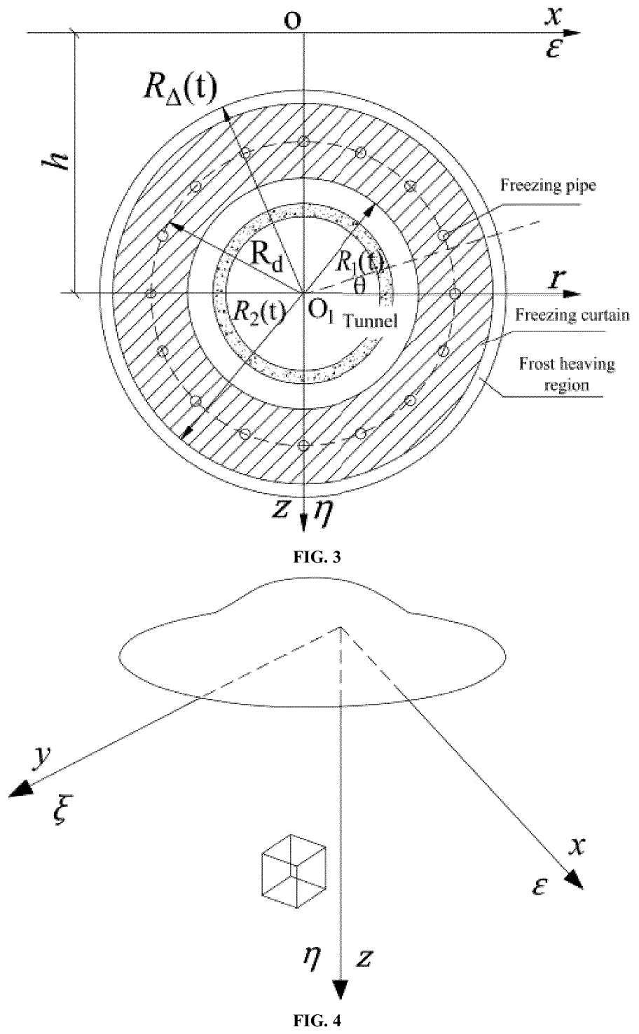

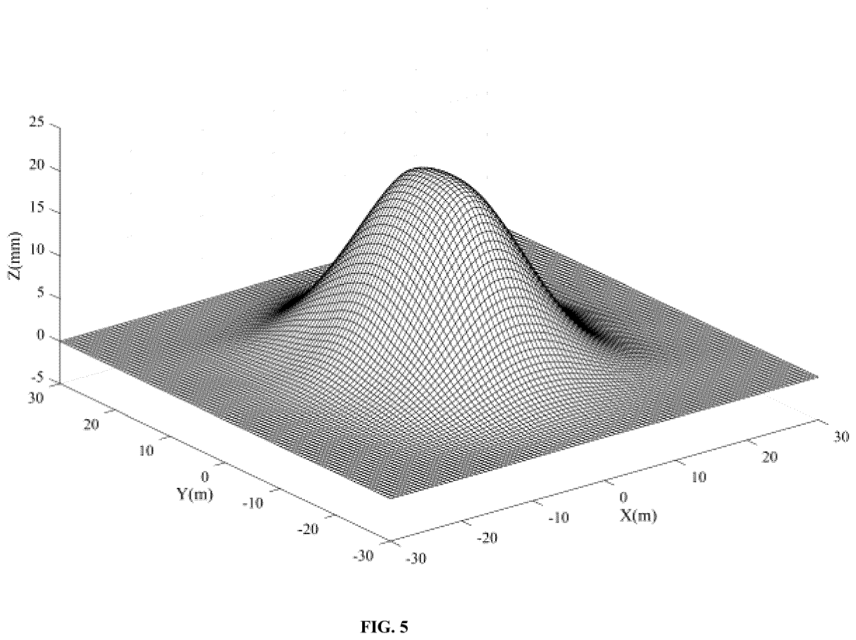

FIG. 1 is a schematic diagram of frost heaving layering according to the present disclosure; FIG. 2 is a diagram illustrating a law of an unsteady freezing front of a single freezing pipe according to the present disclosure; FIG. 3 is a diagram illustrating a law of an unsteady freezing front after closure of a freezing wall according to the present disclosure; and FIG. 4 is a schematic diagram of a formation uplift caused by unit frost heaving according to the present disclosure. Based on the four figures, a method for predicting a three-dimensional frost heaving deformation of a formation during freezing construction of a metro tunnel in the present disclosure includes the following steps:
(1) A freezing construction position is determined; soil horizon parameters of undisturbed soil within a range of a freezing wall are obtained; thermophysical and mechanical parameters of soil, including a density ρ, a thermal diffusion coefficient α, a heat conductivity coefficient k, specific heat c, and phase change latent heat L of the soil, and the frost heaving ratio εⱼ₀ of the soil with no load, are determined; a soil horizon above the freezing wall is layered according to soil properties thereof and existing buildings; and a horizon where a frost heaving influence range exists is determined;
where

$$α = \frac{k}{c ρ} .$$

(2) An unsteady temperature field of a single freezing pipe and a radius r(t) of a freezing front are calculated by the following Formula (1), Formula (2), Formula (3), Formula (4), Formula (5), and Formula (6):

$${T}_{f} = {T}_{c} + ( {T}_{d} - {T}_{c} ) \frac{Ei ( \frac{{r}_{0}^{2}}{4 {α}_{f} t} ) - Ei ( \frac{{r}^{2}}{4 {α}_{f} t} )}{Ei ( \frac{{r}_{0}^{2}}{4 {α}_{f} t} ) - Ei ( \frac{{r ( t )}^{2}}{4 {α}_{f} t} )} ( {r}_{0} \leq r \leq r ( t ) ) \qquad ( 1 )$$

$${T}_{u} = {T}_{0} + ( {T}_{d} - {T}_{0} ) \frac{Ei ( \frac{{r}^{2}}{4 {α}_{u} t} )}{Ei ( \frac{{r ( t )}^{2}}{4 {α}_{u} t} )} ( r ( t ) \leq r < ∞ ) \qquad ( 2 )$$

$${E}_{i} ( x ) = {\int }_{x}^{∞} \frac{{e}^{- n}}{η} d η \qquad ( 3 )$$

$$r ( t ) = A \sqrt{t} \qquad ( 4 )$$

$$\frac{{k}_{f} ( {T}_{d} - {T}_{c} ) {e}^{- \frac{{A}^{2}}{4 {α}_{f}}}}{Ei ( \frac{{r}_{0}^{2}}{4 {α}_{f} t} ) - Ei ( \frac{{A}^{2}}{4 {α}_{f} t} )} + \frac{{k}_{u} ( {T}_{d} - {T}_{0} ) {e}^{- \frac{{A}^{2}}{4 {α}_{u}}}}{Ei ( \frac{{A}^{2}}{4 {α}_{u} t} )} = \frac{{A}^{2}}{4} L \qquad ( 5 )$$

$$L = {L}_{w} {ρ}_{d} ( {w}_{0} - {w}_{u} ) \qquad ( 6 )$$

where T_{f} represents a differential equation for a temperature field of a frozen region; Tᵤ represents a differential equation for a temperature field of an unfrozen region; T_{c} represents a wall temperature of the freezing pipe; T_{d} represents a soil freezing temperature, which is a single soil freezing temperature in case of a homogeneous soil horizon and a freezing temperature of the soil where the radius of the freezing front is located; Ei represents an exponential integral function well known in the art; r₀ represents a diameter of the freezing pipe; T₀ represents an initial environmental temperature; k_{f} represents a heat conductivity coefficient of frozen soil; kᵤ represents a heat conductivity coefficient of unfrozen soil; A represents a coefficient; L_{w} represents latent heat of water; ρ_{d} represents a dry soil density; w₀ represents a water content; and wᵤ represents a water content of unfrozen soil.

α_{f} represents a thermal diffusion coefficient of the frozen region and αᵤ represents a thermal diffusion coefficient of the unfrozen region, which are calculated by the following formulas:

$${α}_{f} = \frac{{k}_{f}}{{c}_{f} {ρ}_{f}} , {α}_{u} = \frac{{k}_{u}}{{c}_{u} {ρ}_{u}} ;$$

where k_{f} represents a heat conductivity coefficient of the frozen region; c_{f} represents specific heat of the frozen region; ρ_{f} represents a soil density of the frozen region; kᵤ represents a heat conductivity coefficient of the unfrozen region; cᵤ represents specific heat of the unfrozen region; and ρᵤ represents a soil density of the unfrozen region.

(3) An inner radius R₁(t) and an outer radius R₂(t) of the freezing front after closure of the freezing wall are calculated according to a tunnel excavation type by the following Formula (7), Formula (8), Formula (9), Formula (10), and Formula (11), and a frost heaving region Δ(t) is calculated by the following formulas:

$${R}_{1} ( t ) = {R}_{d} - B \sqrt{t} \qquad ( 7 )$$

$${R}_{2} ( t ) = {R}_{d} + B \sqrt{t} \qquad ( 8 )$$

$$\frac{{k}_{f} ( {T}_{d} - {T}_{c}^{′} ) {e}^{- \frac{{B}^{2}}{4 {α}_{f}}}}{\sqrt{{α}_{f}} {\int }_{0}^{\frac{B}{2 \sqrt{{α}_{f}}}} {e}^{- {η}^{2} d η}} + \frac{2 {k}_{u} ( {T}_{d} - {T}_{0} ) {e}^{- \frac{{B}^{2}}{4 {α}_{u}}}}{\sqrt{{α}_{u}} [ π - 2 {\int }_{0}^{\frac{B}{2 \sqrt{{α}_{u}}}} {e}^{- {η}^{2} d η} ]} = \frac{BL}{\sqrt{π}} \qquad ( 9 )$$

$$Δ ( t ) = {\int }_{{R}_{1} ( t )}^{{R}_{2} ( t )} ( 1 + {ε}_{f} ) dr = 2 B \sqrt{t} ( 1 + {ε}_{f} ) \qquad ( 10 )$$

$${ε}_{f} = {ε}_{f 0} exp ( - bP ) \qquad ( 11 )$$

where t represents a freezing time; ε_{f} represents a frost heaving ratio of soil under a load; εⱼ₀ represents a frost heaving ratio of soil with no load; P represents a load of the horizon, kPa; b represents a constant of 0.001; B represents a coefficient; r represents a freezing radius; R_{d} represents a distribution radius of freezing pipes; T_{c}′ represents an average temperature of the freezing wall after the closure; and η represents a vertical coordinate direction of the freezing pipe in a cylindrical coordinate system.
(4) A frost heaving displacement Wᵢ(t) of the horizon where the frost heaving influence range exists is calculated by the following Formula (12):

$${W}_{i} ( t ) = - {\int \int \int }_{Δ ( t )} \frac{{tan}^{2} β}{{( {h}_{i} - r sin θ - z )}^{2}} exp \{ - \frac{π {tan}^{2} β}{{( {h}_{i} - r sin θ - z )}^{2}} [ {( x - r cos θ )}^{2} + {( y - ζ )}^{2} ] \} rdrd φ d ζ \qquad ( 12 )$$

where hᵢ represents a height of the horizon where the frost heaving influence range exists to a tunnel; β represents a major influence angle of overlaying soil on the freezing wall; θ represents a polar angle in a polar coordinate system; z represents a z-direction coordinate in a space coordinates system; x represents an x-direction coordinate in the space coordinates system; y represents a y-direction coordinate in the space coordinates system; ζ represents a length direction of the freezing pipe in the cylindrical coordinate system; and φ represents an circumferential angle in the cylindrical coordinate system.

### Example 1

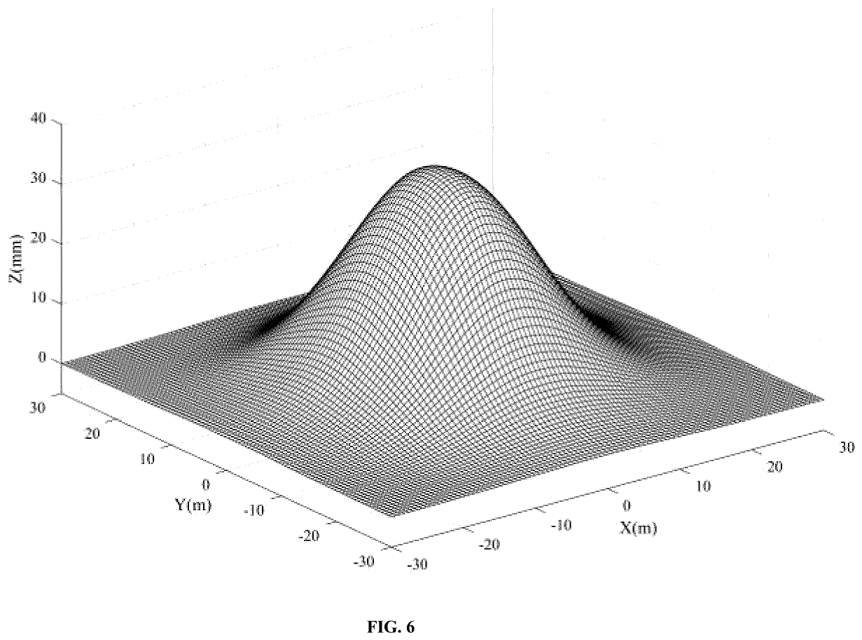

In Example 1, the shallow-buried large cross-section tunnel project on the south side of Dabeiyao to Redianchang section in Fu (xingmen)-Ba (wangfen) line of Beijing metro of China is selected. This project is located directly under Dayao bridge to Guomao bridge, and a plurality of crisscross underground pipelines are distributed in the formation; and phenomena such as water seepage and the like occur frequently because the pipelines are out of repair for long years. In view of this, construction is carried out by artificial freezing. To predict the three-dimensional frost heaving deformation of the formulation of the freezing construction and in consideration of the influence range of freezing construction, a model with a length of 40.0 m, a width of 6.0 m, and a buried depth of the tunnel of 10 m is selected. Soil parameters are obtained according actual working conditions, as shown in Table 1 below, and by a three-dimensional frost heaving prediction method established by Formula (1) to Formula (12), fringes of formation uplifts caused by frost heaving for 60 days and 90 days are obtained by simulation, respectively, as shown in FIG. 5 and FIG. 6. As can be seen from this example, the prediction method of the present disclosure can determine a frost heaving influence range and calculate a frost heaving displacement of a particular horizon in order to determine evolution laws of a freezing curtain and a frost heaving deformation at different stages. The reliability and accuracy of three-dimensional frost heaving prediction of a formation caused by freezing construction of a metro tunnel are improved. It is guaranteed that a prediction result is more conducive to providing reliable data reference and theoretical basis for actual construction.

TABLE 1
Parameters of Soil and Freezing Pipe

| Parameter | Value | |
|---|---|---|
| Density ρ | 1958 | kg/m³ |
| Dry density ρ_{d} | 1489 | kg/m³ |
| Heat conductivity coefficient k_{f} | 31.5 | kcal/(md ° C.) |
| of frozen soil | | |
| Heat conductivity coefficient kᵤ | 25.7 | kcal/(md ° C.) |
| of unfrozen soil | | |
| Specific heat c_{f} of frozen soil | 0.45 | kcal/(kg ° C.) |
| Specific heat cᵤ of unfrozen soil | 0.45 | kcal/(kg ° C.) |
| Water content w₀ | 23.0% | |
| Water content wᵤ of unfrozen soil | 1.0% | |
| Freezing temperature T_{d} | 0° | C. |
| Wall temperature T_{c} of Freezing pipe | −25° | C. |
| Initial temperature T₀ | 20° | C. |
| Frost heaving ratio ε_{f} | 0.56% | |
| Tangent value tanβ of major influence angle | 0.8 | |
| of tunnel | | |
| Thermal diffusion coefficient a_{f} | 0.534 | m²/d |
| of frozen region | | |
| Thermal diffusion coefficient aᵤ of | 0.292 | m²/d |
| unfrozen region | | |
| Distribution radius R_{d} of freezing pipes | 3.25 | m |
| Number of freezing pipes | 8 | |
| Radius r₀ of freezing pipe | 0.054 | m |
| hᵢ | 10.0 | m |
| Freezing time t | 60 or 90 | days |

The embodiments are described herein in a progressive manner. Each embodiment focuses on the difference from another embodiment, and the same and similar parts between the embodiments may refer to each other.

Specific examples are used herein for illustration of the principles and embodiments of the present disclosure. The description of the foregoing embodiments is used to help illustrate the method of the present disclosure and the core principles thereof. In addition, those of ordinary skill in the art can make various modifications in terms of specific embodiments and scope of application in accordance with the teachings of the present disclosure. In conclusion, the contents of the present description shall not be construed as limitations to the present disclosure.

What is claimed is:

1. A method for predicting a three-dimensional frost heaving deformation of a formation during freezing construction of a metro tunnel, comprising the following steps:
(1) determining a freezing construction position, obtaining soil horizon parameters of undisturbed soil within a range of a freezing wall, determining thermophysical and mechanical parameters of soil, layering a soil horizon above the freezing wall, and determining a horizon where a frost heaving influence range exists;
(2) calculating an unsteady temperature field of a single freezing pipe and a radius r(t) of a freezing front;
(3) calculating an inner radius R₁(t) and an outer radius R₂(t) of the freezing front after closure of the freezing wall according to a tunnel excavation type, and calculating a frost heaving region Δ(t) by the following formulas:
$$Δ ( t ) = {\int }_{{R}_{1} ( t )}^{{R}_{2} ( t )} ( 1 + {ε}_{f} ) dr = 2 B \sqrt{t} ( 1 + {ε}_{f} ) ; and$$
$${ε}_{f} = {ε}_{f 0} exp ( - bP ) ;$$
wherein t represents a freezing time; ε_{f} represents a frost heaving ratio of soil under a load; εⱼ₀ represents a frost heaving ratio of soil with no load; P represents a load of the horizon where the frost heaving influence range exists, kPa; b represents a constant of 0.001; B represents a coefficient; and r represents a freezing radius; and
(4) calculating a frost heaving displacement Wᵢ(t).

2. The method for predicting a three-dimensional frost heaving deformation of a formation during freezing construction of a metro tunnel according to claim 1, wherein in step (1), the thermophysical and mechanical parameters of soil comprise a density ρ, a thermal diffusion coefficient α, a heat conductivity coefficient k, specific heat c, and phase change latent heat L of the soil, and the frost heaving ratio εⱼ₀ of the soil with no load, wherein
$$α = \frac{k}{c ρ} .$$

3. The method for predicting a three-dimensional frost heaving deformation of a formation during freezing construction of a metro tunnel according to claim 1, wherein in step (2), the unsteady temperature field of the single freezing pipe is obtained from the following formulas:
$${T}_{f} = {T}_{c} + ( {T}_{d} - {T}_{c} ) \frac{Ei ( \frac{{r}_{0}^{2}}{4 {α}_{f} t} ) - Ei ( \frac{{r}^{2}}{4 {α}_{f} t} )}{Ei ( \frac{{r}_{0}^{2}}{4 {α}_{f} t} ) - Ei ( \frac{{r ( t )}^{2}}{4 {α}_{f} t} )} ( {r}_{0} \leq r \leq r ( t ) ) ; and$$
$${T}_{u} = {T}_{0} + ( {T}_{d} - {T}_{0} ) \frac{Ei ( \frac{{r}^{2}}{4 {α}_{u} t} )}{Ei ( \frac{{r ( t )}^{2}}{4 {α}_{u} t} )} ( r ( t ) \leq r < ∞ ) ;$$
wherein T_{f} represents a differential equation for a temperature field of a frozen region; Tᵤ represents a differential equation for a temperature field of an unfrozen region; T_{c} represents a wall temperature of the freezing pipe; T_{d} represents a soil freezing temperature, which is a single soil freezing temperature in case of a homogeneous soil horizon and a freezing temperature of the soil where the radius of the freezing front is located; Ei represents an exponential integral function; r₀ represents a diameter of the freezing pipe; α_{f} represents a thermal diffusion coefficient of the frozen region; T₀ represents an initial environmental temperature; and αᵤ represents a thermal diffusion coefficient of the unfrozen region.

4. The method for predicting a three-dimensional frost heaving deformation of a formation during freezing construction of a metro tunnel according to claim 3, wherein in step (2), the radius r(t) of the freezing front is obtained from the following formulas:
$$r ( t ) = A \sqrt{t} ; and$$
$$\frac{{k}_{f} ( {T}_{d} - {T}_{c} ) {e}^{- \frac{{A}^{2}}{4 {α}_{f}}}}{Ei ( \frac{{r}_{0}^{2}}{4 {α}_{f} t} ) - Ei ( \frac{{A}^{2}}{4 {α}_{f} t} )} + \frac{{k}_{u} ( {T}_{d} - {T}_{0} ) {e}^{- \frac{{A}^{2}}{4 {α}_{u}}}}{Ei ( \frac{{A}^{2}}{4 {α}_{u} t} )} = \frac{{A}^{2}}{4} L ;$$
wherein k_{f} represents a heat conductivity coefficient of frozen soil; kᵤ represents a heat conductivity coefficient of unfrozen soil; A represents a coefficient; and L represents the phase change latent heat.

5. The method for predicting a three-dimensional frost heaving deformation of a formation during freezing construction of a metro tunnel according to claim 4, wherein in step (3), the inner radius R₁(t) and the outer radius R₂(t) of the freezing front after the closure of the freezing wall are obtained from the following formulas:
$${R}_{1} ( t ) = {R}_{d} - B \sqrt{t} ;$$
$${R}_{2} ( t ) = {R}_{d} + B \sqrt{t} ; and$$
$$\frac{{k}_{f} ( {T}_{d} - {T}_{c}^{′} ) {e}^{- \frac{{B}^{2}}{4 {α}_{f}}}}{\sqrt{{α}_{f}} {\int }_{0}^{\frac{B}{2 \sqrt{{α}_{f}}}} {e}^{- {η}^{2} d η}} + \frac{2 {k}_{u} ( {T}_{d} - {T}_{0} ) {e}^{- \frac{{B}^{2}}{4 {α}_{u}}}}{\sqrt{{α}_{u}} [ π - 2 {\int }_{0}^{\frac{B}{2 \sqrt{{α}_{u}}}} {e}^{- {η}^{2} d η} ]} = \frac{BL}{\sqrt{π}} ;$$
wherein R_{d} represents a distribution radius of freezing pipes; T_{c}′ represents an average wall temperature of the freezing pipe after the closure; and η represents a vertical coordinate direction of the freezing pipe in the cylindrical coordinate system.

6. The method for predicting a three-dimensional frost heaving deformation of a formation during freezing construction of a metro tunnel according to claim 1, wherein in step (4), the frost heaving displacement Wᵢ(t) is obtained from the following formula:
$${W}_{i} ( t ) = - {\int \int \int }_{Δ ( t )} \frac{{tan}^{2} β}{{( {h}_{i} - r sin θ - z )}^{2}} exp \{ - \frac{π {tan}^{2} β}{{( {h}_{i} - r sin θ - z )}^{2}} [ {( x - r cos θ )}^{2} + {( y - ζ )}^{2} ] \} rdrd φ d ζ .$$
wherein hᵢ represents a height of the horizon where the frost heaving influence range exists to a tunnel; β represents a major influence angle of overlaying soil on the freezing wall; θ represents a polar angle in a polar coordinate system; z represents a z-direction coordinate in a space coordinates system; x represents an x-direction coordinate in the space coordinates system; y represents a y-direction coordinate in the space coordinates system; ζ represents a length direction of the freezing pipe in the cylindrical coordinate system; and φ represents an circumferential angle in the cylindrical coordinate system.

7. The method for predicting a three-dimensional frost heaving deformation of a formation during freezing construction of a metro tunnel according to claim 3, wherein
$${α}_{f} = \frac{{k}_{f}}{{c}_{f} {ρ}_{f}} , {α}_{u} = \frac{{k}_{u}}{{c}_{u} {ρ}_{u}} ;$$
wherein k_{f} represents a heat conductivity coefficient of the frozen region; c_{f} represents specific heat of the frozen region; ρ_{f} represents a soil density of the frozen region; kᵤ represents a heat conductivity coefficient of the unfrozen region; cᵤ represents specific heat of the unfrozen region; and ρᵤ represents a soil density of the unfrozen region.

8. The method for predicting a three-dimensional frost heaving deformation of a formation during freezing construction of a metro tunnel according to claim 2, wherein the phase change latent heat L is obtained from the following formula:
$$L = {L}_{w} {ρ}_{d} ( {w}_{0} - {w}_{u} ) ;$$
wherein L_{w} represents latent heat of water; ρ_{d} represents a dry soil density; w₀ represents a water content; and wᵤ represents a water content of unfrozen soil.
